(19) United States
(12) Patent Application Publication
(10) Pub. No.: US 2007/0237603 A1
(43) Pub. Date: Oct. 11, 2007

(54) Quick acting coupling device

(76) Inventor: George A. Sturdevant, Kingwood, TX (US)

Correspondence Address: Loren G. Helmreich;Browning Bushman P.C., Suite 1800, 5718 Westheimer, Houston, TX, 77057, US

(21) Appl. No.: 11/400,614

(22) Filed: Apr. 7, 2006

(51) Int. Cl. F16B 39/36

(52) U.S. Cl. 411/270

(57) ABSTRACT

A quick acting coupling device includes a male member 10 and a female member 32 with an axial opening for receiving the male member. A plurality of circumferentially spaced locking segments 50 are supported on the female member and move radially between an unlocked position and a locked position. A radially inward portion of each of the plurality of locking segments engages a locking groove on the male member when in the locked position, and rotation of the male member relative to the female member does not move the male member axially relative to the female member.

### FIELD OF THE INVENTION

The present invention relates to a device for coupling two members together. More particularly, the invention relates to a quick acting coupling device which does not require rotation of one member relative to another member to join the two members together, and which reliably secures the two members together.

### BACKGROUND OF THE INVENTION

Various types of quick acting coupling devices have been used over the past several decades. A typical quick acting coupling device includes a bolt or other male member having an external thread along a portion thereof, and a female member or nut which receives the male member. In order for the device be quick acting, circumferentially spaced locking segments are provided on the second member and are radially movable between an outward unlocked position and inward locked position. This enables the locking segments to “ratchet” outward as a male member is pressed into the female member (rotation is not required), and then final torque may be applied to the male member relative to the female member to obtain the desired coupling of the members. Quick acting coupling devices of this type are disclosed in U.S. Pat. Nos. 5,324,150, 5,378,100, 5,437,488, and 4,378,187.

A modified quick coupling nut is disclosed in U.S. Pat. No. 6,974,291, and a variation of a quick mounting nut is disclosed in U.S. Pat. No. 6,854,944. U.S. Pat. No. 6,712,574 discloses a quick acting nut with three circumferentially spaced inserts. Yet another version of a quick mounting nut is disclosed in U.S. Pat. No. 6,632,058.

U.S. Pat. No. 6,406,240 discloses a fast acting coupling with threaded arcuate segments, and another variation of a quick locking fastener is disclosed in U.S. Pat. No. 6,361,260. A coupling device with a push-on mounting is disclosed in U.S. Pat. No. 6,033,169, and a nut for slidable application to a bolt is disclosed in U.S. Pat. No. 6,007,284.

A press nut for easily attaching and detaching the nut from a bolt is disclosed in U.S. Pat. No. 5,944,467, and a variation of a press-type nut is disclosed in U.S. Pat. No. 5,902,085. A quick connect device is disclosed in U.S. Pat. No. 5,876,071, and a male coupling with movable threaded segments is disclosed in U.S. Pat. No. 5,788,443. U.S. Pat. No. 5,749,691 discloses a nut with cam member which moves a primary ring member from a rest position to an axially displaced position.

U.S. Pat. No. 5,324,150 discloses a quick acting coupling assembly with threaded segments. The different type of quick fastening nut is disclosed in U.S. Pat. No. 5,032,048. U.S. Pat. No. 4,684,284 discloses an anti-rotation lock assembly.

A significant problem with prior quick acting coupling devices relates to the tendency of the coupling device to loosen over time, particularly when subjected to vibration. This is a significant problem for many applications, such as subsea applications, where long term interconnection is required. Over time and with vibration, the male member may slowly rotate relative to the female member, although the locking segments remain retained in the radially inward or locked position, so that the male member essentially unthreads from the nut.

The disadvantage of the prior art are overcome by the present invention, and an improved quick acting coupling device which reliably secures two members together is hereinafter disclosed.

### SUMMARY OF THE INVENTION

In one embodiment, a quick acting coupling device includes a first male member, such as a bolt or stud, which has a plurality of axially spaced annular locking grooves along an outer portion thereof. A female member includes an axial opening for receiving at least a portion of the first member therein. A plurality of circumferentially spaced locking segments each supported on the second member are radially movable between a radially outer unlocked position and a radially inward locked position, such that a radially outward portion of each of the locking segments engages a locking groove when in a locked position, and rotation of one member relative to the other does not move one member axially relative to the other. A biasing member is provided for biasing each of the locking segments radially inward.

According to one embodiment of a method, the male member is formed with a plurality of axially spaced annular locking grooves along an outer portion thereof, and a female member is formed with an axial opening for receiving at least a portion of the male member therein. A plurality of locking segments are each supported on the female member, and are radially movable between a radially outward unlocked position which allows at least a portion of the plurality of locking segments to move past one or more of the plurality of locking grooves, and a radially inward position wherein axial movement of the male member with respect to the female member is prevented. A radial outward portion of each of the plurality of locking segments engages a locking groove when in the locked position, and rotation of the male member relative to the female member does not move the male member axially relative to the female member. The assembly cannot become loosened by vibration or rotation of one member relative to another member.

These and further features and advantages of the present invention will become apparent from the following detailed description, wherein reference is made to the figures in the accompanying drawings.

### BRIEF DESCRIPTION OF THE DRAWINGS

FIG. 1 is a side view of a suitable male member according to the present invention.

FIG. 2 is an end view of the male member shown in FIG. 1.

FIG. 3 is a side view of a suitable female locking member.

FIG. 4 is an end view of the female locking member shown in FIG. 3.

FIG. 5 is a side view of the locking segments prior to be positioned within the female member.

FIG. 6 is an end view of the locking segment shown in FIG. 5.

FIG. 7 is a side view of a coupling device assembly according to the invention.

FIG. 8 is a side view of the coupling device assembly with a retractable female member.

FIG. 9 is an enlarged view of a portion of the assembly shown in FIG. 8 in the released or unlocked position.

### DETAILED DESCRIPTION OF PREFERRED EMBODIMENTS

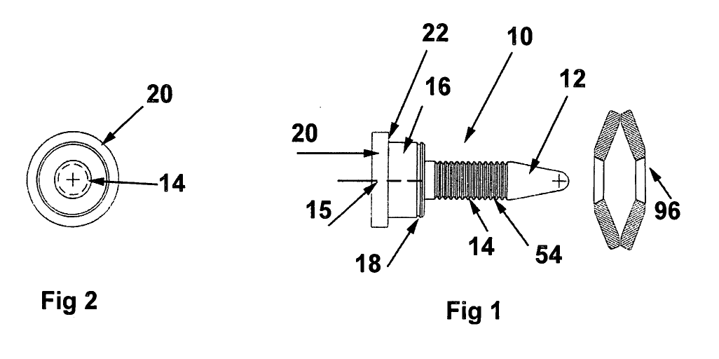

Referring to FIG. 1, a suitable male member or stud 10 is disclosed, including a guide nose 12 having an external tapered surface thereon, and a plurality of axially spaced grooves 14. The axially spaced grooves are not threads, but rather are preferably each within a plane substantially perpendicular to an axis 15 of the stud 10, for reasons explained below. The stud also includes an enlarged head portion 16 having an outer diameter substantially greater than the outer diameter of the annular threads 14, a retaining grooves 18, and a head cap 20. A suitable device, such as a panel, may have one panel face engaged with the inner surface 22 of the head cap 20 and another panel face engaged by a suitable annular stop, such as a clip or retainer, which fits within the groove 18 to effectively sandwich the panel between the head cap 20 and the retainer. FIG. 2 is a front view of the male member shown in FIG. 1, and illustrates the diameter of the head cap 20 relative to the axially spaced grooves 14.

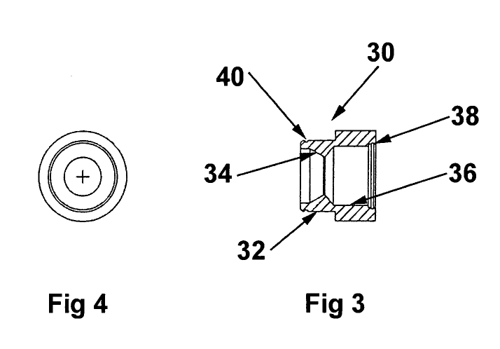

FIG. 3 depicts a female member 30 having a receiving portion 32 with a tapered inner surface 34 for receiving the first member, and particularly the guide nose 12, when the first member is moved into engagement with the second member. The second member 32 also includes a locking segment cavity 36 for receiving a plurality of locking segments discussed subsequently, and a retaining groove 38 for retaining the locking segments within the cavity 34. A suitable C-ring clip or other retainer (not shown in FIG. 3) may thus be snapped into the groove 38 to effectively secure the locking segments within the second member. The second member also includes a groove 40 for receiving a retaining member functionally similar to the retaining member which fits into the groove 18 discussed above. In this manner, the second member may also sandwich a panel or other device between the shoulder 42 and the retaining member within the groove 40.

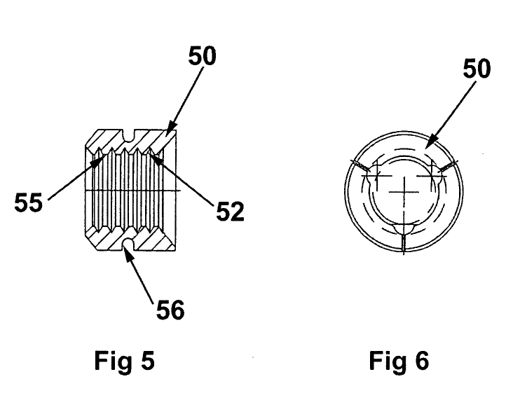

FIG. 5 depicts in cross-section three circumferentially spaced locking segments 50 which fit within the receiving cavity 32 in the second member 30. Each locking segment includes a plurality of axially spaced interior grooves 52, so that each groove 52 receives a corresponding projection 54 formed by the locking grooves 14 on the stud 10 when the first and second members are locked together. Each projection 55 on the locking segments between the grooves 52 thus locks within a respective groove 14 on the stud 10. FIG. 5 also shows a circumferential external groove 56 in each of the locking segments 50. The three grooves 56 may receive a biased retainer, such as a small diameter coil spring wound in the shape of an O-ring, which biases the segments 50 radially inward, and causes the segments to move together radially between the unlocked and locked positions when the stud 10 is inserted into the female member and the projections pass by each other.

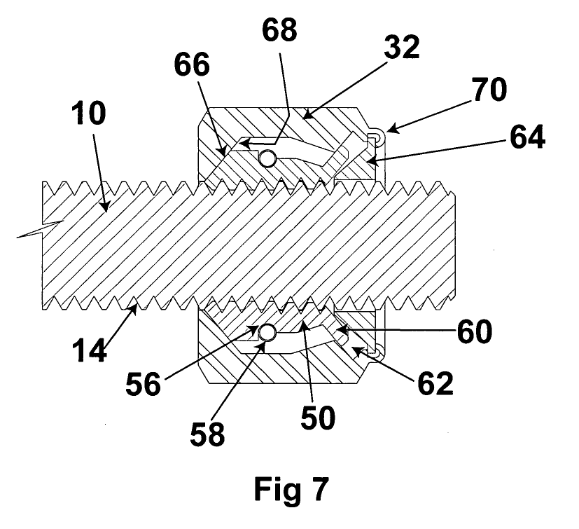

Referring now to FIG. 7, a cross-section of portion of a male member 10 is shown which includes the annular grooves 14 positioned within a different version of the female body 32. The slips 50 are shown within the body 32, and a coiled spring 58 is depicted in the grooves 56 for retaining the slips in a radially inward position. Each slip segment includes a slanted, radially outward projection 60 which slides into the recess 62 between the body 32 and the end cap 64 as the segments move radially outward, with the lower surface 66 of each segment sliding up the mating surface 68 of the female member. Surfaces 66 and 68, and projection 60 and the sides of recess 62, thus act as a guide surface for sliding engagement when running the segments between the locked and unlocked positions. When the female body and the slips are assembled, end cap 64 is positioned to engage the body 32, and lip 70 is crimped over to hold the end cap in place. The lip 70 thus serves a purpose similar to the C-clip and the groove 38 shown in FIG. 3.

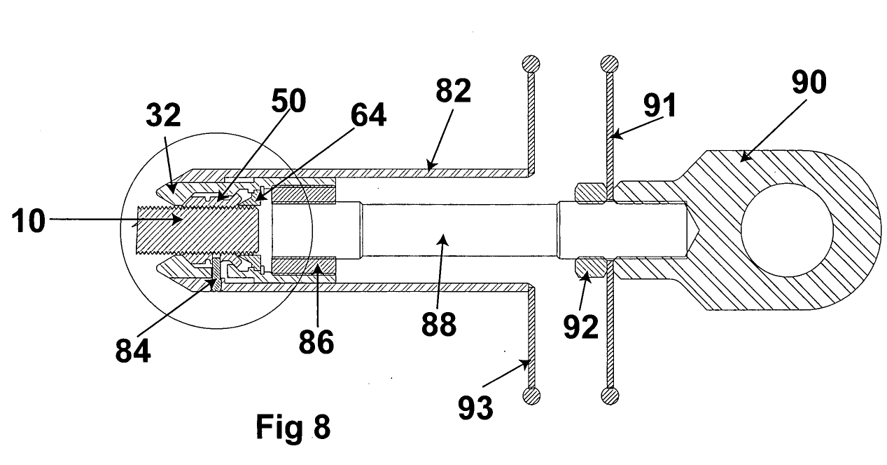

FIG. 8 shows another embodiment of a quick acting coupling device which prevents the male member from unthreading from the female member, but which also allows the male member to be retracted from the female member. For this embodiment, a sleeve 82 is provided radially outward of the female body 32, and is axially moveable with respect to the female body 32, as explained subsequently. A pin 84 structurally interconnects the sleeve 82 and each of the slip segments 50. An intermediate body 86 connects the female body 32 to the central post 88, which has a handle 90 at the upper end thereof. Plate 91 extends outward from the post 88, and is retained in the position by nut 92. Another plate 93 extends outward from the sleeve 82. Pulling plate 93 toward plate 91 moves the slip segments to the unlocked position, so that the male member 10 can be withdrawn from the slips.

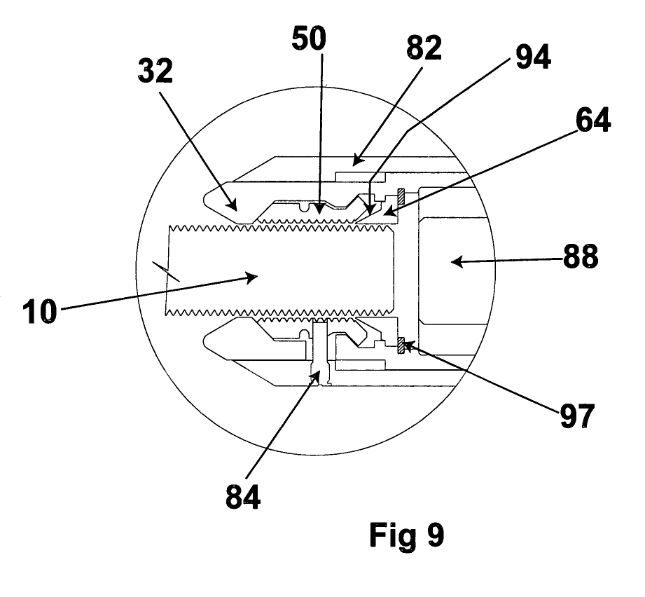

FIG. 8 depicts the assembly in the locked position, and FIG. 9 illustrates the unlocked position. To unlock, an operator may pull the plate 93 toward plate 91, thereby pulling up on sleeve 82 relative to the female member 32. FIG. 9 shows the sleeve 82 pulled upward, which moves the pins 84 and the slips 50 axially closer to the end of post 88 and thus closer to the end cap 64. As the slips move up the cam surface 94, the slips are drawn radially outward to a position such that the projections between the grooves of the male member completely disengage from the projections between the grooves on the slip segments 50, thereby allowing one to pull the male member outward from the female member. Those skilled in the art will appreciate that in FIGS. 8 and 9, coil spring 58 is not shown for clarity of the depicted components. Also, receiving clip 97 shown in FIG. 9 is used to fix the position of the cap 64 relative to the female member 32. A similar but radially larger clip may be used to fit in the groove 18 shown in FIG. 1.

Those skilled in the art will appreciate that both the male member 10 and the female member 32 may have a variety of configurations for different applications. In some embodiments, the nose portion 12 is not required, but the male member does include a plurality of annular grooves axially spaced along a stud portion of the male member. The slips include mating grooves, and the projections between grooves engage to lock the male and female parts together. Rotation of one member relative to the other does not affect the locking relationship, since the grooves are not spiral grooves.

Various mechanisms may be used for biasing the slips radially inward, while allowing their radially outward movement as the male member is pushed into the female member and the slips “ratchet” inward and outward during this movement. Also, different techniques may be used to push the segments radially outward when a slip disengaging member is moved relative to the slips, or the slips are moved relative to the slip disengaging member.

As disclosed herein, each of the annular locking grooves in the male member may have a substantially V-shaped cross-sectional configuration, with a similar cross-sectional configuration for the grooves on the inner surface of the locking segments. In other embodiments, grooves may be provided with different cross-sectional configurations for the locking grooves, and also for the projections between grooves which each fit within a corresponding groove on the other member. Since the final axial position of the two members when locked together may vary, the circumferential recesses are provided at a uniform axial spacing.

The coupling device may make substantially rigid connection between the male and female members. The coupling device may also be used with a biasing member, such as a wave spring washer, which provides an axial biasing force between the two members when in the locked position. The biasing member may thus generate a selected separating force between the two members when in the locked position. FIG. 1 shows a suitable biasing member 96, such as one or more Belleville springs, aligned for being positioned on the male member.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A quick acting coupling device, comprising:
a first male member having a plurality of axially spaced annular locking grooves along an outer portion thereof;
a second female member having an axial opening for receiving at least a portion of the first male member therein; and
a plurality of circumferentially spaced locking segments each supported on the female member and radially movable between a radially outward unlocked position which allows at least a portion of the plurality of locking segments to move past one or more of the plurality of annular locking grooves, and a radially inward locked position wherein axial movement of the male member with respect to the female member is prevented, and a radially inward portion of each of the plurality of locking segments engages a locking groove when in the locked position, and rotation of the male member relative to the female member does not move the male member axially relative to the female member.

2. A quick acting coupling device as defined in claim 1, further comprising:
a biasing member for biasing each of the plurality of locking segments radially inward.

3. A quick acting coupling member as defined in claim 1, wherein the plurality of circumferentially shaped locking segments includes three or more locking segments circumferentially spaced within the female member.

4. A quick acting coupling device as defined in claim 1, wherein each of the annular locking grooves on the first member has a substantially similar V-shaped cross-sectional configuration.

5. A quick acting coupling device as defined in claim 1, wherein each of the plurality of locking segments include a plurality of axially spaced locking projections thereon each for engaging the corresponding axially spaced locking groove.

6. A quick acting coupling device as defined in claim 1, further comprising:
each of the first member and the second member including a planar surface substantially perpendicular to an axis of the axial opening; and
a biasing member for biasing one planar surface axially toward another planar surface.

7. A quick acting coupling device as defined in claim 1, wherein the male member includes a front guide nose having a tapered surface for guiding the male member into the axial opening in the female member.

8. A quick acting coupling device as defined in claim 1, wherein each of the plurality of locking segments includes a guide surface for sliding engagement with the second member when moving between the locked and the unlocked position.

9. A quick acting coupling device as defined in claim 1, further comprising:
a retainer groove on the first member for receiving a circumferential retaining member, the retaining member limiting axial movement of the first relative to a member engaged by the retaining member.

10. A quick acting coupling device as defined in claim 1, further comprising:
a retaining groove on the second member for receiving a circumferential retaining member, the retaining member limiting axial movement of the second member relative to a member engaged by the retaining member.

11. A quick acting coupling device, comprising:
a first male member having a plurality of axially spaced annular locking grooves along an outer portion thereof;
a second female member having an axial opening for receiving at least a portion of the first male member therein; and
three or more circumferentially spaced locking segments each supported on the female member and radially movable between a radially outward unlocked position which allows at least a portion of the plurality of locking segments to move past one or more of the plurality of annular locking grooves and a radially inward locked position wherein axial movement of the male member with respect to the female member is prevented, and a radially inward portion of each of the three or more locking segments engages a locking groove when in the locked position, and rotation of the male member relative to the female member does not move the male member axially relative to the female member; and
a biasing member for biasing each of the three or more locking segments radially inward.

12. A quick acting coupling device as defined in claim 11, wherein each of the annular locking grooves on the first member has a substantially similar V-shaped cross-sectional configuration.

13. A quick acting coupling device as defined in claim 11, wherein each of the plurality of locking segments include a plurality of axially spaced locking projections thereon each for engaging the corresponding axially spaced locking groove.

14. A quick acting coupling device as defined in claim 11, wherein the male member includes a front guide nose having a tapered surface for guiding the male member into the axial opening in the female member.

15. A quick acting coupling device as defined in claim 11, further comprising:
a first retainer groove on the first member for receiving a first circumferential first retaining member, the retaining member limiting axial movement of the first relative to a member engaged by the first retaining member; and
a second retaining groove on the second member for receiving a circumferential second retaining member, the retaining member limiting axial movement of the second member relative to a member engaged by the retaining member.

16. A method of connecting a first male member with a second female member having an axial opening for receiving at least a portion of the first male member therein, comprising:
forming a plurality of axially spaced annular locking grooves along an outer portion of the male member;
supporting a plurality of circumferentially spaced locking segments on the female member, each locking segment being radially movable between a radially outward unlocked position which allows at least a portion of the plurality of locking segments to move past one or more of the plurality of annular locking grooves and a radially inward locked position wherein axial movement of the male member with respect to the female member is prevented, and a radially inward portion of each of the plurality of locking segments engages a locking groove when in the locked position, and rotation of the male member relative to the female member does not move the male member axially relative to the female member; and
moving the first member into the axial opening in the female member to cause the plurality of locking segments to move between the locked position and the unlocked position.

17. A method as defined in claim 16, further comprising:
biasing each of the plurality of locking segments radially inward.

18. A method as defined in claim 16, wherein each of the annular locking grooves on the first member have a substantially similar V-shaped cross-sectional configuration.

19. A method as defined in claim 16, wherein each of the plurality of locking segments include a plurality of axially spaced locking projections thereon each for engaging the corresponding axially spaced locking groove.

20. A method as defined in claim 16, further comprising:
providing a retaining groove on the second member for receiving a circumferential retaining member, the retaining member limiting axial movement of the second member relative to a member engaged by the retaining member; and
providing a retaining groove on the second member for receiving a circumferential retaining member, the retaining member limiting axial movement of the second member relative to a member engaged by the retaining member.
